(19) United States
(12) Patent Application Publication
(10) Pub. No.: US 2007/0016117 A1
(43) Pub. Date: Jan. 18, 2007

(54) Hair-treatment or removal utilizing energy-guiding mechanisms

(76) Inventors: John W. Sliwa JR., Los Altos, CA (US); Carol A. Tosaya, Los Altos, CA (US)

Correspondence Address: David W. Collins - Intellectual Property Law, Suite 100, 512 E. Whitehouse Canyon Road, Green Valley, AZ, 85614, US

(21) Appl. No.: 11/485,589

(22) Filed: Jul. 11, 2006

Related U.S. Application Data
(60) Provisional application No. 60/698,996, filed on Jul. 12, 2005.

(51) Int. Cl. B26B 21/00

(52) U.S. Cl. 601/46; 30/32

(57) ABSTRACT

In a first embodiment, an ultrasonic or vibratory energy apparatus is provided for at least one of ultrasonically, vibrationally, thermally or ablatively treating at least a first portion of at least one hair, hair-shaft, hair root-structure, hair root-region, hair-follicle, hair-related scalp tissue or hair-supporting vasculature. In a second embodiment, an optical, radio-frequency or microwave treatment energy-delivery apparatus is provided for at least one of thermally, ablatively or photo-optically treating at least a first portion of at least one hair, hair-shaft, hair root-structure, hair root-region, hair-follicle, hair-related scalp tissue or hair-supporting vasculature.

### CROSS-REFERENCE TO RELATED APPLICATION

The present application claims priority from provisional application Ser. No. 60/698,996, filed Jul. 12, 2005.

### BACKGROUND ART

I. Hair-Removal Means Known to Provide at Least Temporary Hair-Reduction and, in Some Cases as Indicated, some “Permanent” Hair-Reduction in Selected Patients with Repeated Long-Term Treatment of a Given Hair-Follicle

a) Shaving. This works very nicely but provides only 1-3 day-long effects. Shaving requires the use of a lubricant or moisturizer to avoid skin damage or abrasions. Shaving can cause razor-burn, bumps, nicks, cuts and ingrown hairs. Shaving is cheap and “do-it-yourself”.

b) Laser Ablation. A laser illuminates multiple root-regions of the scalp and purportedly destroys the hair roots but not the scalp tissues. In reality, this process is moderately selective and a cooling means must still be provided to protect scalp tissue between hairs as best as possible. Some scalp tissue is still damaged and irritated. It appears that laser-treatment, to date, is a temporary treatment that can slow down hair reappearance. Laser treatment works best in light-skinned persons with dark hair, as they have the highest optical absorbtion contrast between hair and tissue. One laser treatment can provide a benefit for 6 months but can cost $500 and still cause redness and irritation. Post-treatment cold packs are frequently used to reduce inflammation and swelling. Persons with gray hair are unable to benefit from laser-therapy.

c) Wax Treatments. Molten wax is poured or hot-molded onto the skin, small tissue sections at a time, and literally peeled (ripped) off after solidification. It is a very painful and irritating procedure. Data seems to say this is a temporary and not a permanent measure despite advertising. To make it “permanent”, one repeats the procedure every 6 weeks or so. Waxing can cause redness and bruising. The benefit of a waxing lasts 3-6 weeks and also strips off dead skin cells. People with diabetes or who use acne medications should avoid such wax materials. Waxing can cause ingrown hairs. Care must be taken to avoid thermal burns with waxing. “Sugaring” replaces the wax with a solidified sugar concoction that is likewise peeled but has the advantage of easy residue cleanup using water. Wax residue can be painful to strip.

d) Electrolysis. A needle capable of passing an electrical current into the follicle to thermally ablate the hair-root is inserted into or directly next to the hair follicle. One or more repeated treatments can destroy the hair and allow for easy tweezing. Electrolysis is very slow, quite expensive, and can cause hypo/hyper-pigmentation. Treatments are typically repeated over 12-18 months. Pain and infection are possible. Electrolysis is regarded as the “most permanent” treatment. Electrolysis can cause dry skin, scabs, scarring, and inflammation. Needle sterilization is absolutely vital. It is impractical from the patient-point of view to do large areas of the skin such as the back for time and cost reasons.

e) Depilation-Creams. These dissolve hair, cause irritation, and smell quite badly. The effects are temporary if not repeated regularly. The creams are quite expensive. They typically contain thioglycolate mixed with sodium hydroxide or calcium hydroxide. The hair is dissolved; however, some skin-tissue is also dissolved, even if the procedure is done correctly. The resulting residue is washed off. Sometimes hydrocortisone cream is used afterwards to reduce irritation. The benefit of a treatment lasts 3-14 days. Depilation sometimes causes allergic rashes and/or may not work on coarse hairs.

f) Plucking/Tweezing. Usually done daily, this can cause follicle infections, swelling, and skin discolorations. Must be repeated on a near-daily schedule for “permanent” effect. Removes the hair from below the tissue surface so it will be a period of time before the hair regrows to and beyond that surface. If treatment is repeated to the same hair shaft, the effect might be permanent hair removal, but this is very slow. Individual plucking lasts for 3-8 weeks. The tweezers need to be sterilized to avoid infections.

g) Threading. A twisted thread is used to pull out hairs. The treatment is fast, painful, can cause ingrown hair, is irritating, can cause folliculitis, and can cause pigmentation changes. It is more painful than individual hair tweezing.

h) Biological and Drug Treatments (genetic, enzymes, hormones, etc.). Vaniqa™ is an FDA-approved topical cream for facial hair inhibition and removal. It utilizes eflornithine-hydrochloride, which inhibits an enzyme needed for cell reproduction. Results are seen in 4-8 weeks. It requires continued use for “permanent” effect. Anti-androgen medications are another alternative, which block the production of androgen, a hair-growth hormone.

i) Bleaching. This basically lightens hairs by removing pigmentation so they are not as easily visible, it does not remove the hairs. It is used on arms, face, and neck. It is not really fair to describe this procedure as “hair-removal”; it is not.

Examples of other hair removal procedures include: j) RF treatment (experimental); k) heat treatment (experimental); l) steam treatment (experimental); m) chemical treatments (local and systemic); and n) blanket non-selective acoustic treatment.

II. Hair-Growth Encouragement Means Known to Provide at Least Temporary Growth and Some Long-Term Hair-Growth Activity in Selected Patients with Continued Treatment

a) Topical Chemical Treatments. Rogaine™ from Pfizer is probably the best known and most widely used topical treatment. It is applied twice per day a milliliter at a time and allowed to dry and be absorbed into the scalp for 20 minutes or so. Clinical data appears to support the benefit of its use in many patients.

b) Supplements. Male hair loss can be caused by a chemical called dihydrotestosterone (DHT). A naturally occurring enzyme in the body called 5 alpha-reductase transforms the male hormone testosterone into DHT. DHT is the main cause of thinning hair and receding hairline in men. Certain herbs and minerals, in the proper mixture, can bind with 5 alpha-reductase and block DHT formation. Supplements with the correct ingredients can halt the effects of DHT, and even assist in the regrowth of hair, particularly in men ages 18-40. Some of these supplements include Procerin™, HairGenesis™, Propecia™, Avacor™, and Shen-Min™. Data appears anecdotal.

c) Diet, Vitamins, and Minerals.—The list of purported beneficial diets, vitamins and minerals is a very long and unsubstantiated one. A slew of untested products, many of them having the same or similar ingredients, are available, mostly in unproven form. Data appears anecdotal.

III. Prior Art

US2005/0072372 to Hynd et al, “Hair-Removal And Animal Husbandry Method”.

This application teaches the application of a collagen cleaving agent or enzyme on a blanket-basis. Any assisting heat or power, if used, is also blanket-applied. Thus, inter-hair tissue is fully exposed to enzyme and any assisting power. The subject animals scabbed considerably and even then the results lasted for several months only. This reference does not teach the high hair/intervening scalp selectivity of our invention nor does it teach any hair-growth treatments. It also does not teach any form of selective energy delivery.

US2005/0049657 to Jay et al, “Hair Treatment Method”.

This application teaches the use of unidirectional light energy delivered to one side of hair-shafts only for the purpose of cutting hair shafts either above or below the scalp line using only photothermal mechanisms. Essentially this is an above skin or below skin thermal shaver. In the below-skin mode, the hair reappears at a later date than using the at-scalp line cutting mode, as would be expected for a hair which first needs to again grow back to the surface. The hair or its cellular apparatus are not claimed to be damaged or killed and the result is described as temporary as would be expected. We note explicitly that one or a few hairs are sucked or otherwise drawn into the unidirectional light path. Because most of the light path is not blocked by hairs to be treated, most of the energy, perhaps (more than 99.8%) is wasted and a large energy source is required. “Selectivity” here is provided by the fact that only hairs are in the unidirectional light path. However, one has no idea where in the relatively wide light path, so high-power light must be delivered to all of it. No attempt is made to conserve energy making a personal device, and particularly an optics-based high-intensity light device expensive and bulky. Further, the user could be blinded by looking into the treatment slit. Mention of other electromagnetic or ultrasonic co-treatment is in the prior art nonselective blanket-manner and is not said to directly contribute to the taught hair cutting. This application does not teach any wave guiding action. The scalp-contact plate is shown preferably flat, thus, severely limiting how one could cut several laterally displaced hairs at once to the same height. Further, hairs not being arranged along a line will still all be sucked in, resulting in those hairs being cut to different lengths. Hairs may also foul the apparatus after being sucked in, and outgassing of superheated hairs will certainly foul the reflectivity of mirrors and obscure other optical components. Heating of hairs, even those few in the unidirectional light path, is inefficient because it is one-sided or from only one face. Our invention preferably delivers hair-directed surrounding energy that is more than twice as efficient.

US2005/0049543 to Anderson et al, “System And Method For Treating Tissue”.

This application teaches pinching lumps of tissue in a clamp that delivers a treatment energy or radiation. It does not teach how to selectively target hair-portions nor even localized groups of cells. Prior art pinching or clamping and burning apparatus, not mentioned, exist for purposes of AF or atrial fibrillation treatment, for example. No selective energy guidance is taught even for the large treatment targets discussed.

US2004/0260210 to Ella et al, “System And Method For Face And Body Treatment”.

This application essentially attempts to offer an integrated skin/face treatment system supporting a variety of sequential or simultaneous known treatments applied over macroscopic tissue regions. The invention does not teach new treatments, nor treatments for a localized hair region; what it does is offer a way to integrate numerous prior art treatments which all address macroscopic large portions of tissue at a time. There is no hair-selective treatment in the manner of our invention mentioned or taught.

US2004/0260209 to Ella et al, “System And Method For Face And Body Treatment”.

This application is essentially the same material as 2004/0260210 above.

US2004/0236269 to Marchitto et al, “Microsurgical Tissue Treatment System”.

This application teaches the use of a vibrating pad with abrasive for treating macroscopic tissue portions. Microabrasion of tissue is practiced using a number of supporting medicaments and process-monitors. This is a very nicely written patent application, but again, it is arranged for macroscopic skin treatment and does not even mention hairs. Microns of tissue are removed everywhere.

US2004/0230258 to Altshuler et al, “Method And Apparatus For Treating Pseudofolliculitis Barbae”.

This application teaches the use of lasers to modify the shape or elastic-stiffness of hairs prone to become ingrown. Also, large swaths of tissue are addressed and no means to treat a single hair is taught. Again, treatment is not for the purpose of hair-removal or invigoration.

US2004/0223985 to Dunfield et al, “Method And Device For Targeted Delivery Of Medicinal, Cosmetic And Related Agents”.

This application teaches the use of targeted drug delivery to skin tissues. It essentially utilizes inkjet technology to do so. The drawback of this invention is that extensive and accurate means to visualize or image the desired targets is required. An example of hair-removal is given wherein the hair-removal medicament or depilatory is aimed at a follicle. Again, this is probably very expensive and impractical when a rub-on drug can do the same job. The basic question about this application is whether there is any real need for aiming such microvolumes of drugs. In any event, this is a drug-based treatment only and is not applicable to our invention.

US2004/0077977 to Ella et al. “System And Method For Face And Body Treatment”.

This application is essentially the same as that of US2004/0260209 and 2004/0260210 above.

IV. Hair Types, Hair Growth and Hair Loss

There are two types of hair: fine soft hairs called vellus, which provides some degree of thermal insulation, and longer coarse hair called terminal hair, which offers physical cushioning. All hair is made of the hard protein keratin also found in fingernails and toenails. At any given time, about 90% of the hairs on one's scalp are in a growing (anagen) phase, a phase which lasts for 2-6 years. Hairs then enter a very short transitional (catagen) phase lasting 2-3 weeks. At any point in time, less than 1% of scalp hairs are in the transition phase. The third phase is the resting (telogen) phase, which lasts for 2-3 months, at the end of which the hair is shed and the growing phase starts over again. The most common cause of hair loss in men and women is androgenetic alopecia or AGA. Heredity, hormones and age all play a part in this condition. In AGA, the hair follicle shrinks.

### SUMMARY OF THE INVENTION

In a first embodiment, an ultrasonic or vibratory energy apparatus is provided for at least one of ultrasonically, vibrationally, thermally or ablatively treating at least a first portion of at least one hair, hair-shaft, hair root-structure, hair root-region, hair-follicle, hair-related scalp tissue or hair-supporting vasculature. The apparatus comprises:
an ultrasonic or vibratory energy transduction-means or energy-source capable of producing or providing ultrasonic or vibratory excitation energy;
an ultrasonic or vibratory energy coupling-member or coupling-medium which, when energy-coupled to a second portion, is capable of passing ultrasonic or vibratory energy from the member or medium into, upon, through or along the second portion;
the coupling member or medium and the energy means or source being the same, shared, or separate cooperating components;
the first and second portions being different or the same portion and being portions of the same or different hairs, hair-shafts, hair root structures, hair root regions, hair-follicles, hair-related scalp tissues or hair-supporting vasculature;
ultrasonic or vibratory energy thereby being deliverable into, upon, through or along the second portion from or by at least one of the coupling member or means, the energy transduction means or source, or by the cooperation of both; and
at least some of the ultrasonic or vibratory energy delivered or coupled at the second portion at least one of: a) at least partly propagating, conducting or passing as ultrasonic or vibratory energy to or into the first portion, or b) being at least partly converted to heat in one or more portions and being at least partly thermally propagated to or into the first portion, or c) being converted, at least partly, to heat at or in the first portion, d) at least partly arriving at, or propagating to the first portion as both some ultrasonic or vibratory energy and as some heat or thermal-energy, e) at least partly being propagated or conducted through, along or into at least one other portion, and/or f) being coupled to and employed to treat the same portion.

In a second embodiment, an optical, radio-frequency or microwave treatment energy-delivery apparatus is provided for at least one of thermally, ablatively or photo-optically treating at least a first portion of at least one hair, hair-shaft, hair root-structure, hair root-region, hair-follicle, hair-related scalp tissue or hair-supporting vasculature. The apparatus comprises:
an optical, radio-frequency, microwave or electromagnetic energy-source capable of at-least delivering or providing optical, radio-frequency, microwave or electromagnetic energy;
a means to energy-couple said source-energy into, onto or along a second such portion;
the first and second portions being different or the same portion and being portions of the same or different hairs, hair-shafts, hair root structures, hair root regions, hair-follicles, hair-related scalp tissues or hair-supporting vasculature; and
at least some of the treating-energy delivered or coupled at the second portion at least one of: a) at least partly propagating, conducting or passing, in the form of the treating energy, to or into the first portion, b) being at least partly converted to heat by attenuation in one or more portions and thereby being at least partly thermally propagated to or into the first portion, c) being converted, at least partly, to heat at or in the first portion, d) at least partly arriving at, or propagating to the first portion as both some treating energy and as some heat or thermal-energy, e) at least partly being propagated or conducted through, along or into at least one other portion, or f) being coupled-to and employed to treat the same portion,

wherein the first and second portions are different portions or the same portions.

### BRIEF DESCRIPTION OF THE DRAWINGS

By way of explanation of the inventive embodiments we shall refer to the following Figures, which are not necessarily to scale, unless otherwise stated.

FIG. 1 is a schematic structure of a hair and surrounding tissues.

FIG. 2A is a perspective view, partially in section, of an ultrasonic energy delivery apparatus coupling ultrasonic energy directly into a hair-shaft and, in turn, to a hair root, in accordance with an embodiment of the invention.

FIG. 2B is a perspective view, partially in section, of an ultrasonic energy delivery apparatus coupling ultrasonic energy into surrounding scalp tissue and, in turn, to a hair root, in accordance with an embodiment of the invention.

FIG. 3A is a perspective view, partially in section, of an apparatus delivering an attenuating energy into a hair-shaft that is attenuated to heat used to treat a hair root, in accordance with an embodiment of the invention.

FIG. 3B is a perspective view, partially in section, of an apparatus delivering an attenuating energy into surrounding scalp tissue that is attenuated to heat used to treat a hair root, in accordance with an embodiment of the invention.

FIG. 4A is a perspective view of a comb-like or hair-sorting treatment apparatus, in accordance with an embodiment of the invention.

FIG. 4B is a cross-sectional view of a brush-like or hair-sorting treatment apparatus, in accordance with an embodiment of the invention.

FIG. 5 is a cross-sectional view of a coated-hair treatable by a treatment apparatus.

FIG. 6 is a cross-sectional view of a handheld version of an exemplary apparatus of the invention that is ultrasound/vibration powered and designed to kill or remove multiple hairs.

FIG. 6A is an enlargement of a portion of FIG. 6.

### DETAILED DESCRIPTION OF THE PREFERRED EMBODIMENTS

In a first embodiment, acoustic energy is delivered through hair shafts to the hair roots, using the hair shafts as acoustic waveguides. At lower acoustic power levels, the treatment accelerates and invigorates hair growth. At higher power levels, the treatment can destroy the viability of the hair root and supporting cellular matter, resulting in hair-removal. What is novel is the use of the hair shafts as acoustic waveguides such that acoustic treatment is delivered, selectively, directly to the hair roots and not to scalp tissues between such root regions. The inventive acoustic means may be arranged to treat one hair at a time or multiple hairs at a time, even in a home setting. Numerous disadvantages of the prior art procedures are avoided.

In a second major embodiment, thermal heat is delivered to the hair roots, using the hair shaft as a thermal conductor. In this second embodiment, the heat is delivered to the hair, is generated in the hair, or is generated in a hair-coating near the scalp. What is novel is that hair shafts are employed at least to carry heat into the root if not also to generate that heat in the hair shafts in an energy-attenuative process. The hair root is treated with energy delivered from the hair itself.

In both embodiments, one gains superior spatial selectivity with regards to avoiding the burning of scalp tissues away from the hair-roots and the many complications of that, such as pigmentation changes and pain. The fact that the hair is substantially delivering therapy energy that is self-focused on the hair root allows one to avoid conventional complications, as any heating effect falls off as something like the inverse of distance (1/d) from the hair shaft. In both the second embodiment thermal cases, one or many hairs can also simultaneously be treated, unlike electrolysis. In both cases, the prior art optical-selectivity of the hair versus the tissue is not an issue.

The prior art involving the use of lasers, for example, has required a high optical absorption contrast difference between hairs and the scalp tissue because optical energy was inevitably delivered to both. This invention sidesteps that challenge by delivering no energy to scalp regions between hairs.

It will be noted that there exists a major market for removal of gray hair which is untapped because of the slowness and expense of electrolysis and because of the lack of laser therapy optical-selectivity for light hair or pigment-depleted hair. The invention solves that problem and alleviates the listed drawbacks of prior-art techniques.

While acoustic or vibratory treatment is the preferred approach of the invention, the treatment energy wave guiding principle also applies to our additional taught embodiments including optical, radio-frequency and microwave treatments. In all cases, we have the preferential flow of treatment energy, or heat caused thereby, from an energy delivery-site or portion to a typically separate treatment site or portion.

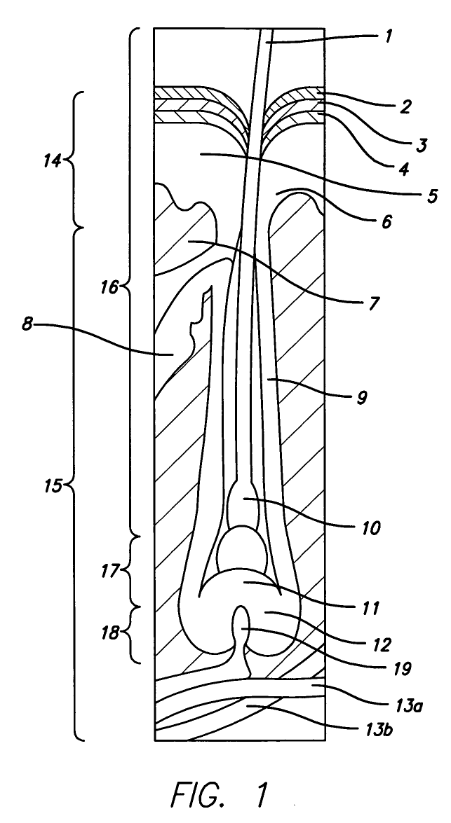

FIG. 1 is a schematic diagram of a hair including its direct parts, surrounding related or supportive parts, and zonal terminology, which are commonly referred to in the literature when discussing hairs. In the center is the hair shaft 1. It is seen embedded in the skin layers, those layers comprising the horny layer 2, the hyaline layer 3, the granular layer 4, the spinous layer 5, the basal layer 6, the reticular layer of the dermis 7, the sebaceous gland 8, the outer root sheath 9, the keratinization zone 10, the differentiation zone 11, the generation zone 12, and the hair papillae 19. Also note the arterial and vascular blood paths 13a and 13b biologically supportive of the hair. On the left hand side of FIG. 1, we see the zonal view of a hair and related tissue structure. In the broadest view, we have two skin zones, an upper epidermis zone 14 and an underlying dermis zone 15. It can be seen that within those two skin zones are three more sub-zones that are hair-related, namely, the hair root zone 16 and the included and underlying hair bulb zone 17 and follicle matrix zone 18.

The inventive apparatus and method are designed to treat what we shall refer to and define now as “portions”. By “treating a portion” we typically mean that at least the portion receives a treatment energy and that treatment energy has a beneficial treatment effect on at least a subspace or subpart of that portion. Thus, one could direct treatment energy into a hair-root region (portion) yet only be interested in ablating some highly localized genetic material therein. In other cases, the entire portion will be beneficially treated as well as exposed, as for example if substantial tissue is to be ablated. A portion can be a hair portion or a tissue or vasculature portion biologically or physically supportive of the hair in question. It can also be the hair's local sebaceous gland. So a hair-portion, for example, could be a hair-shaft, hair-bulb, hair-follicle matrix or any part or all of the hair root-zone, hair bulb-zone or follicle zone. These include all of FIG. 1 items numbers 1-19 as well as any other known hair parts. By “supportive” we mean that the portion is at least partly biologically or physically dedicated or supportive of its nearby local hair or portion thereof in terms of its growth or health-maintenance. Thus, treating a supportive portion of a hair is treating a portion just like treating a portion of a hair-root. The portion may be quite small, such as part of or all of the outer root-sheath or hair-papillae or may be large in that it includes all of the hair parts and even some of the supportive tissues or vasculature surrounding it. So what all portions have in common is that they either are hair parts or are supporting tissue, gland or vascular structure or blood. We also include in the scope of the invention, as mentioned, a portion being very small, such as being genetic material. Note that the invention may be arranged, in its various embodiments, to treat one or more portions of one or more hairs or hair-supporting parts or zones sequentially or simultaneously. Treated portions may vary from very small, e.g., some localized genetic material in the bulb/follicle region, to quite large, such as treating complete hair-shafts and their surrounding tissues at several hairs simultaneously. Also included in the scope, as stated above,.is the treatment of sebaceous glands for any reason as we regard them and define them herein as treatable portions which are hair-related. We explicitly note that an energy-treated region or portion may contain targeted sub-matter, the best example being targeting of a hair-root portion wherein the true target is the localized genetic material therein. Note that since the treated portion volume may be larger than the benefited sub-volume, that one can assure addressing of the sub-volume by encapsulating it in a larger treated portion that is to all or mostly receive energy.

So a portion may be a part of or even a whole structure such as an entire hair and all of its supporting skin-related tissue and vasculature, or might alternatively be only part of (a portion on a hair-root structure such as a follicle matrix or part thereof. Another critical point of the invention is that we deliver or couple a first energy to treat the first hair portion or portions. This first energy is one of: a) delivered directly to the treated first portion, or 2) is delivered to a second portion and passed to, guided to or conducted to the first portion from the second portion, or 3) a combination of both of (1) and (2). Thus, the treated first portion and the second portion to which energy is delivered or coupled into may be the same or different portions. In cases wherein the treated first portion and the delivery second portion are totally different or separate (choice 2), treatment energy must be passed to or propagated from the second delivery portion to the first treatment portion. The invention includes in its scope the self-guiding or even waveguide action of portions such as hair-shaft portions to accomplish this purpose. As an example, a hair-shaft has the inherent ability to selectively pass ultrasonic, RF or heat energy along its length. This phenomenon can be quite useful such as in the case wherein we treat a beneath-scalp first portion from an above-scalp hair-shaft second portion. Note that the hair-shaft is capable of selectively guiding energy along its length downwards (or even upwards) into the targeted sub-scalp or other target region. Our inventive treatments may comprise one or more energy exposures or doses or one or more energy types or modes. As an example, a first energy exposure could dry out the surrounding root-sheath such that a second energy exposure is more selectively passed along the length or shaft of the remaining hair to the follicle. Likewise, a first energy-exposure could increase the attenuation (or conduction) of energy used in a second energy exposure step.

Finally, we note that the delivered or coupled first energy delivered to the second portion may be, by the time it is propagated or conducted to the treatable first portion, partly or fully converted to a second energy form. An example of this is first ultrasonic energy coupled into an above-scalp hair-shaft second portion that is propagated downwards to a treatable hair-root first portion. Note that because of known ultrasonic attenuation effects (or optical, RF or microwave attenuation effects), one can arrange for the first ultrasonic energy (or optical, RF or microwave energy) traveling downwards to the hair-root to arrive at the treatable first portion as any of a) mostly first ultrasonic energy (or optical, RF or microwave energy), b) first ultrasonic (or optical, RF or microwave) energy and some second attenuative heat-energy, or even c) mostly second attenuative heat-energy. Those familiar with ultrasonic (or optical, RF or microwave) energy-propagation will be aware that using the hair as an acoustic (or optical, electrical or transmission-line) waveguide allows us to form the byproduct heat in a highly-selective spatial manner, for example, near or at the hair-root after it has been guided down the hair-shaft.

Since we include in the scope of “portions” scalp-portions immediately or biologically supportive of hairs of interest, the invention may also be employed in a manner wherein, for example, a scalp-portion surrounding or underlying a hair is either the object of treatment (a first portion) or is a portion whereat energy or converted heat is coupled (a second portion). Note that if one were to treat a first hair-root region or portion, for example, one could get treatment energy to that targeted first portion either or both of by passing treatment energy downwards from a hair-shaft second portion or passing energy downward through an alternative second portion comprising hair-adjacent scalp tissue. Thus, although the invention may treat or pass treatment energy through some hair-adjacent or hair-underlying scalp tissues, it does not treat the scalp as a simultaneous whole nor does it expose the scalp as a whole to any treatment energy.

We shall define the “selectivity” of our inventive treatments to mean that we substantially avoid the dumping of energy into scalp-tissues, hairs and hair-portions not immediately associated with the targeted portion(s). Prior-art techniques such as laser-treatment of hairs have been attempted, unsuccessfully to date, by dyeing the targeted hairs such that a laser beam larger than the hair-shaft would be only “weakly” absorbed in scalp tissues not intended to be treated. The fact is that such selectivity is, even in the best case, modest selectivity such that the unintended target tissue or hairs still receive at least some significant treatment and/or require physical protection to prevent damage. Our embodiments are selective in that we expose tissues and hairs that are not to be treated to no significant treatment energy, typically by selective physical application or irradiation, selective physical coupling, selective routing, wave-guiding or self-guiding as we mentioned. In this manner, we do not irritate or inflame large portions of the scalp like the prior art pseudo-selective techniques. It is quite telling that people with light hair or gray hair are still today untreatable with laser techniques. Our technique, in many of its embodiments, is totally unaffected by hair color or skin-tone. Note that because of our superior essentially infinite selectivity, we can utilize very high power, if necessary, without concern for unrelated scalp damage.

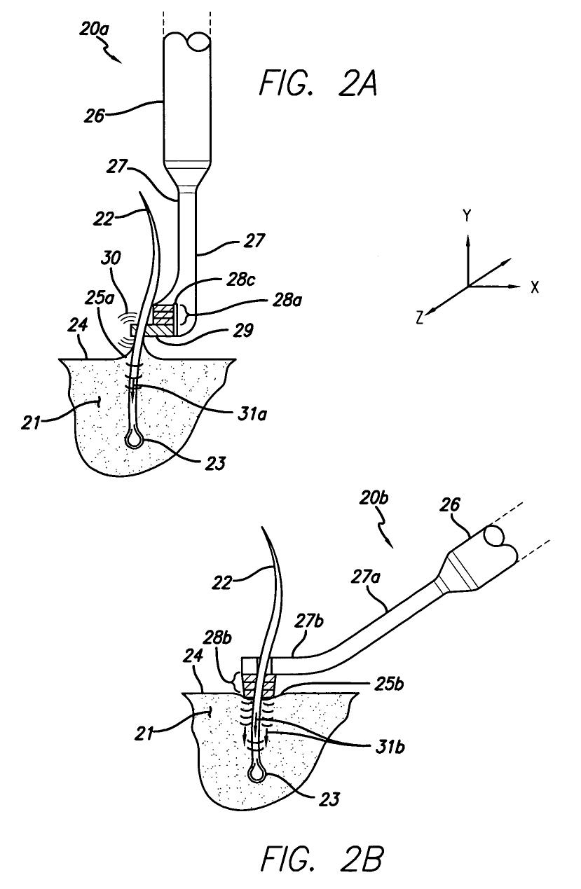

Moving now to FIG. 2A, we see depicted an embodiment of an inventive ultrasonic apparatus for hair-removal. The apparatus 20a (shown not to scale) is shown gripping a hair 22 which is to be removed or killed. Looking first at apparatus 20a, we see that it has a general shape of a cylindrical handle 26 and an extension portion 27. At the tip of extension portion 27 we see a piezoelectric transducer 28a that is arranged to vibrate or oscillate a hair-gripping or coupling member 29. It will be seen that the piezoelectric transducer 28a is a multi-laminate type having several internal interdigitated electrodes as is known to the art for reducing driving voltages. The transducer 28a can oscillate up and down along the ±Y axis and vibrate the attached hair-clamp 29. Note that the transducer 28a is bonded to the extension 27 only on its top surface, whereas there is a gap 28c on the right and side of transducer 28a to allow vibration.

Hair clamp or coupler 29 is shown gripping hair 22. This clamping may be by squeezing, pinching, adhesively-bonding, electrostatically clamping, etc., and the important aspect is simply that the ultrasonic energy can be transferred into the hair 22 from the vibrating coupler 29. Hair 22, although not depicted in detail, would be pinched, clamped or otherwise gripped as it passes through clamp 29. Hair 22 is depicted as growing in tissue 21 whose tissue surface is at 24. The hair 22 is shown as having a hair bulb or root 23 as would be expected from our FIG. 1. We show some ±Y vibrations of the coupler 29 as waves 30. Note that we also show some of that ultrasonic energy coupled into the hair shaft 22 as acoustic waves indicated by arrow 31a propagating toward the hair root 23. The apparatus 20a is shown clamped to the hair 22 in a manner such that the user (user's hand not shown) is preloading the hair slightly upwards (+Y direction), resulting in an expected tenting or distortion of the tissue 25a immediately surrounding the hair 22. Such tenting is not required but would be present for schemes that tensile-load the hair 22. The ultrasonic transducer 28a would typically be electrically powered as by (not shown) an external console, batteries, a fuel cell or other power-pack. As an example, the apparatus 20a of FIG. 2A might have an operational ultrasonic frequency of 300 KHz, which results in a major portion of the ultrasonic energy making it down the hair-shaft before attenuation takes place. Thus, the hair-root can be treated, at least somewhat acoustically, as opposed to only thermally. So the important point of FIG. 2A is that energy coupling is to the hair-shaft 22 in order to treat below-skin portions such as 23. We also note that hairs 22 frequently exit the skin at an angle and that our apparatus 20a may easily be arranged to align to and tension a hair at an appropriate exit-angle (not shown).

Moving now to FIG. 2B, we see a similar apparatus 20b with a few key differences from that of the FIG. 2A apparatus 20a. To begin with, apparatus 20b still has a handle 26 but now has an angulated two-part extension 27a/b. A hair 22 situated in a patient's tissue 21 is still to be treated to kill the root structure 23. Note that in FIG. 2B, the hair 22 is captured or surrounded by a generally annular piezoelectric transducer 28b (transducer 28b seen in section). Transducer 28b directs treatment ultrasonic energy 31 b downwards into and through skin tissues that directly surround or are adjacent to the target hair 22. It will be noted that the downward passing acoustic energy 31b is also depicted as being partially picked-up by the subdermal portion of the hair-shaft. In any event, the point of FIG. 2B is that we may utilize a portion of hair-related skin tissue to deliver at least some treatment energy, the treatment energy in this example then propagating to the hair root 23 from around and/or inside the hair 22 for treatment thereof. Again, as for FIG. 2A, if we were to choose the operational frequency to be 300 KHz, then we would get significant acoustical energy into the hair shaft and hair root before losing any of it to attenuative heat. We explicitly note that transducer 28b might both direct energy downwards into the sub-dermal tissue and/or shaft (shown) and/or couple energy sideways at the surface into the hair shaft 22 (not shown) for downwards guidance. As shown, transducer 28b is primarily coupled through hair-adjacent scalp tissue.

Those familiar with acoustic attenuation will be aware that as we raise the ultrasonic frequency up to 1-2 MHz from a few hundred KHz, we will cause more and more of the delivered energy to be converted into heat at higher and higher levels in the hair-shaft closer and closer to the point of energy delivery. So if the treatment is to be even partly acoustic in nature at the targeted first portion, one must choose a frequency that reaches the target before complete attenuation to heat. Typically, this will be below 1 MHz and most often below 500 KHz. If the treatment is designed to be mainly thermal, then one will raise the frequency more in the general range of 750 KHz to 2 MHz. It is the known directional trend of attenuation versus frequency that is most important to note.

The ultrasonic transducers of FIG. 2A (28a) and FIG. 2B (28b) are depicted as thickness-mode devices, as are widely utilized. The invention is, however, not limited to thickness-mode devices nor even to piezodevices. Note also that in FIG. 2B we actually depict the tissue 24 to be slightly deformed downwards as the transducer 28b is acoustically coupled to the tissue surface, preferably with a gel or liquid (not shown) and a slight downward force in the −Y direction.

Finally, in FIGS. 2A and 2B, we stress that these Figures are not to scale in that the target hairs 22 are shown grossly oversized for illustrative purposes.

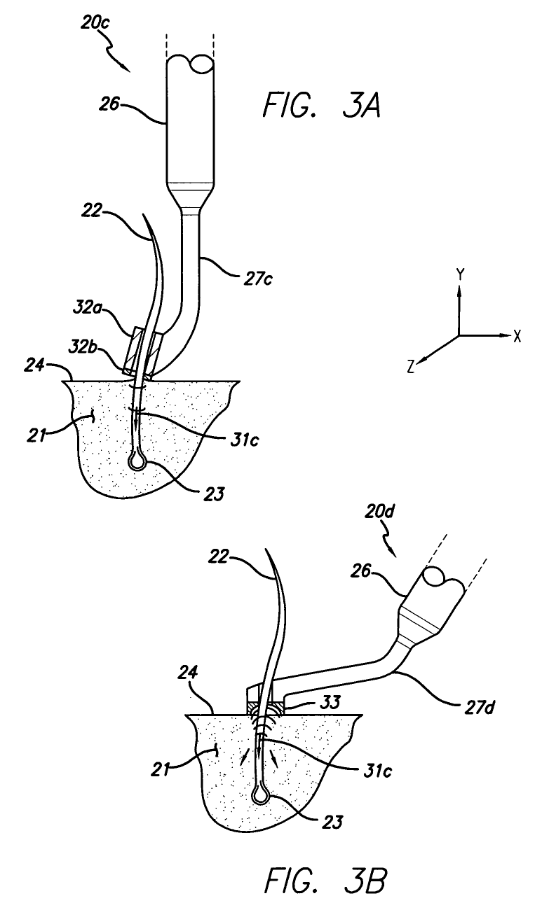

Moving now to FIGS. 3A and 3B, we see two embodiments of apparatuses of the invention, arranged to deliver a first energy which is purposely substantially attenuated to second heat energy or heat for thermal treatment of the hair root 23. In FIG. 3A, we see yet another hand tool 20c apparatus having the familiar extension 27c which is curved this time. However, in FIG. 3A, we have an energy delivery transducer 32a which is designed to deliver a first energy, for example, RF or ultrasonic energy, which is to substantially be attenuated to heat for thermal treatment of hair root 23. As an example, item 32a could be an RF driving coil operating at 13.56 MHz as is known to the RF art. The hair 22 exposed to this RF will attenuate that RF and be heated. The coil or antenna 32a may be arranged or provided with focusing elements (not shown) such that the RF energy is directed toward the hair-root 23 or hair shaft 22. Energy 31c is depicted as passing or propagating toward root 23 as some RF energy and some heat energy. The delivered first energy of FIG. 3A could also be ultrasonic energy, for example, 1.5-2.5 MHz ultrasonic energy. Ultrasonic energy of this high a frequency will certainly partially attenuate usefully to heat at least in the keratin structure of the hair 22 and in its surrounding sheath and root structures 23. Item 32b is an RF shield that can optionally be utilized to prevent direct RF heating of scalp tissue away from the hair shaft if scalp tissue is not to be directly heated.

Notice that in FIG. 3A we could have also coupled RF or microwave energy to the hair shaft via a physically-contacting RF electrode or microwave antenna (not shown), as opposed to a shown non-contacting (contact not necessary) coil. This physical-contact scheme is electrically similar to an electrocautery knife or scalpel wherein an electrical current flows into the cutting edge and diffuses outward to a large-area electrode frequently placed on the patient's underside. We explicitly note that if FIG. 3A used a contacting RF electrode, then the treatment energy, per the inventive theme, is selectively dumped into the hair shaft. As the electrical RF current conducts away from the hair root, the current density drops precipitously at a rate between 1/D² and 1/D³, with D being the lateral distance from the hair shaft. Thus, the treatment heating effect is highly localized (selective), whereas the return current itself is spread out.

Moving now to FIG. 3B, we see a similar device as that in FIG. 3A with the exception that the first energy is being coupled, at least partly, through the tissue immediately surrounding a hair 22. This is analogous to FIG. 2B except that here in FIG. 3B, the delivered first energy (for example, again RF or ultrasound) is chosen to purposely, at least partly, attenuate to heat in the superficial and/or subdermal tissue and/or hair-structure. Again, as for FIG. 3A, we depict energy 31c in the form of some first energy and some heat energy propagating to the hair root 23.

From physics, we know that certain energy types favorably propagate along certain paths either because the conductivity of the path is higher or because the paths provide or cause waveguide-like reflections and refractions which entrain the energy to a hair-shaft, for example. Steps can also be taken to enhance selective energy travel. Later we will describe waveguiding hair enhancement coatings and electrical conductivity-enhancement coatings. Here we mention that a treatment energy can be delivered in various phases, one or more of the earlier phases being used to enhance the conductivity, attenuation or coupling-ability of a later phase's energy form. As an example, an RF energy could carbonize part of a hair shaft such that it acts more like an RF energy guide for a later RF delivery phase.

A hair 22 has a bone-like or fingernail-like acoustic impedance higher than that of tissue. Because of this, ultrasonic energy already in the hair shaft will tend to follow the hair as opposed to suddenly all leak out into the surrounding sub-dermal tissue 21. Included in the scope of our invention is the utilization of any favored propagation path in order to get an energy to propagate further or selectively. Known favored propagation phenomena include but are not limited to:
1) Guiding of ultrasound via acoustic impedance discontinuities or gradients.
2) Guiding of ultrasound via passage through favored waveguide shapes, possibly having dimensions which are integer or fractional multiples of key acoustic wavelengths to further enhance the benefit.
3) Guiding of optical energy due to favorable index-of-refraction dis-continuities or gradients.
4) Guiding of optical energy via passage through favored waveguide shapes.
5) Guiding or steering of RF or microwave energy due to waveguide or transmission-line effects.
6) Favored routing of any energy along a low-attenuation or high-conductivity path for that energy.
7) Favored routing, improved coupling or improved attenuation due to the use of an enhancement chemical or coating.

So by “guiding” we simply mean that an energy's propagation is favored in a particular direction or sub-volume, typically in a general direction of a treatable portion, such as along a curved or straight hair-shaft to its underlying treatable hair root. Those familiar with energy propagation know that sometimes particular wave modes or harmonics are transmitted more easily relative to others. As an example, acoustic modes having resonant frequencies with a hair diameter or length can be propagated or, conversely, attenuated more effectively. Thus, the purposeful choosing of or encouragement of the formation of such favored modes is within the scope of the invention, as is automatic discovery and setting (matching) of energy and coupling parameters and/or locations for such optimal coupling.

In order to either of enhance propagation (or reduce attenuation) or enhance attenuation (reduce propagation) of an energy in or through a portion(s), it may be beneficial to treat or coat the hair-shaft or portion with a surface-coating or a volume-treating chemical. For example, an acoustic propagation enhancement coating on above-scalp hair shafts would help assure that most or all acoustic energy coupled into the above-scalp hair-shaft makes it into the subsurface hair portions. Such a coating could increase the effective hair-diameter using any low attenuation material such as an oil, gel or varnish. By the same token, a coating could increase the optical, RF or microwave transmissivity into the sub-scalp hair portions along or through a hair portion or hair-shaft, or alternatively, could increase the optical, RF or microwave attenuation above the scalp for the same portion or shaft favoring conversion or attenuation to treating thermal energy. All such coatings, etchings, treatments or impregnations to any hair or scalp portion(s), whether to improve propagation or to encourage energy-conversion or attenuation, are included in the scope of the invention, regardless of whether they are formed or caused using chemicals, oils, gels or a propagated energy or are formed using an energy deposition method such as carbonizing of a hair-shaft or other hair-portion via RF-energy deposition. By “coating” we also include etching (surface or bulk), conversion coatings or layers (surface or bulk) or deposited coatings regardless of the deposition processes. The “coating” will enhance at least one of energy absorbtion, energy propagation, energy mode-conversion, or energy attenuation.

Note that with a coating a hair may pass most or all of its treating energy through the coating, especially lengthwise, in a manner similar to a wire or optical fiber.

Thus, our invention is capable of a) delivering a first energy which itself treats a local or remote portion, b) delivering a first energy which is, at least partly, converted to a second energy form, at least the second form delivering some treatment to the local or remote portion, or c) delivering a first energy which is completely (substantially) converted to a second energy form before arriving at the treatable portion, that portion treated with some of the converted second energy only or mainly. The second energy form may be thermal heat as generated by attenuation of the first energy. It may also be a second form or energy which can even be nonthermal, such as photo-optical or electromagnetic energy of modest intensity such as to avoid significant heating.

As a general statement, when the object of treatment is to kill hairs or stop hair growth, the energy delivered will be higher in intensity and/or duration and more destructive than energy delivered to facilitate hair growth. Typically, destructive effects can be expected with tissue-heating above about 47-50 degrees C. for ten seconds or longer to cause thermal ablation or with exposure to destructive acoustic cavitation. Lesser heating or acoustics that do not involve destructive cavitation can be used to nonablatively stimulate perfusion, enzyme and protein reactions and cell-membrane transport in known manners. It is within the scope of the invention that an inventive apparatus may be capable of delivering an energy at various levels or doses such that either or both of a destructive or nondestructive treatment can be carried out with a given apparatus. Further, it is anticipated that the inventive apparatus may be provided as a kit having multiple different transducers or couplers. This would allow, for example, different wavelength or frequency energies most favorable to particular portions to be delivered. Those familiar with HIFU or destructive ablative ultrasound therapy know that acoustic power densities for tissue-matter are usually in the 500-3,000 watts/cm² power range. If only cavitation is desired, then powers can be as low as a few watts per cm² for low frequencies in tissue-matter. Also, if nondestructive non-cavitating effects are desired, as possibly for some hair-growth enhancement treatments, the delivered power densities may be in the range of a few watts per cm² to a couple of hundred watts/cm² with lower powers for lower frequencies where it is easier to cavitate. We note that in hair itself, that is, keratin-heavy bonelike material, power levels will likely be reduced from the above tissue-based values particularly for long pulses or exposures. We also note that the thermal mass of a hair-portion or hair-root, for example, is hugely smaller than that of the underlying skull bone. Thus, short pulses delivered to hairs and hair roots will not significantly heat skull bone especially if the duty cycle allows for a cooling period between pulses and/or auxiliary cooling means such as coolants or cold-pads are used with or after energy depositions. Despite this flexibility, we expressly include with the inventive apparatus the ability to control temperatures of the apparatus and/or subject-tissues as by the use or flow of a heat-exchange medium such as water

By hairs or hair portions we include all manner of bodily hairs including hairs of the scalp, chest, legs, abdomen, back, tummy, private-parts, face, nose, ears, eyebrows, beard, goatee, moustache, eyelashes, arms, armpits, feet, ears, etc. We also include treatment of hairs on or in any living being or creature of any type, including all mammals, humans and all types of hair-growing pets. Such hairs would typically be natural hairs but could also be transplanted hairs.

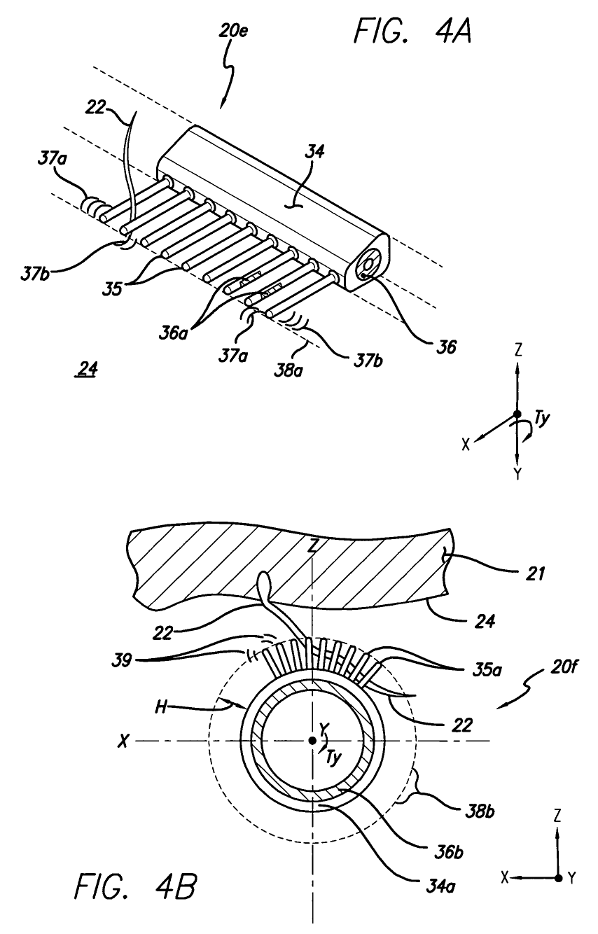

Moving now to FIG. 4A, we depict a perspective view of a part of a comb-like apparatus 20e. The comb-like apparatus 20e has a backbone 34 with numerous attached comb-like teeth 35. It can be seen that the backbone 34 is arranged along the Y-axis and the comb-like teeth 35 are pointed generally along the X-axis. A single hair shaft or scalp hair 22 is shown passing through the marked “gap” between the first two shown teeth 35.

Looking at the sectioned end of the backbone 34 in FIG. 4A, one can see an internal cylindrical hole in which is situated or fitted a tubular piezoelectric transducer 36. Ideally, this is a known shearing type transducer that, when electrical voltage is applied, causes shear distortions across the tubular wall thickness. It will now be apparent to those familiar with vibration or acoustics that by oscillating the transducer 36 in shear across its tubular wall thickness we can cause it to inertially apply a torque to the comb backbone 34 around the shown Y-axis. We have vectorially shown such a rotational torque Ty on the coordinate system Y-axis for FIG. 4A. By choosing the torque to be oscillatory or pulsed and having a predetermined repeat frequency, we can then set that driving frequency to be a natural frequency or harmonic of one or more parts of the comb backbone 34, piezotube 36 or comb teeth 35 (in bending, for example). We have depicted comb teeth 35 vibrating (in bending) up and down with upward deflections 37a and downward deflections 37b. So, in this case of harmonically bending comb teeth 35, one can choose the natural vibrational frequency of the comb tooth 35 to match a driving frequency of the piezoelement 36 to enhance coupling.

Typically, piezotube 36 would be driven with a sine wave, resulting in reversing harmonic torques ±Ty and preferably resonant deflections 37a/b of the comb-like teeth 35. Such piezotube 36 driving might also be unipolar, rather than bipolar, and might be single-pulsed, multi-pulsed or continuous CW or continuous-wave.

Inspecting FIG. 4A further, we also see piezoelements 36a embedded in comb-like teeth 35. These may be used in addition to or instead of using the piezotube 36.

The operation of the apparatus of FIG. 4A is as follows. The hair (or hairs) 22 is (or are) gripped, at least temporarily, as it is dragged through or held in the narrow gap between the teeth 35. During the period of the gripping-action (or intermittent gripping action such as with stick-slip contact), the gripping teeth are oscillating up and down (motion indicated by 37a/37b) and they transfer vibrational energy into the hair shaft 22 and subsequently downwards and upwards in the untrimmed (as shown) hair shaft 22. The transferred energy is utilized as the first energy of the invention for treatment of a first portion, which might be the sub-dermal hair-root, for example. By “gripping” we mean suitably coupling for the mode and form of energy to be transferred.

By making the tooth 35 gaps narrower than the hairs 22 and purposely allowing for stick-slip motion of the hair through the gaps when moving the comb 20e, one can enhance the momentary repeated contact phenomenon as the hair is dragged through the comb teeth 35. Note that the piezoelement or piezotube 36 may also be used to cause the teeth 35 to harmonically vary their gaps, as well as transferring energy to the hair (not shown). Piezoelements 36a could also perform bending of the teeth to achieve pseudo-static or static gripping or clamping. Thus, the piezoelement 36 can both cause the momentary sticking contact of hairs when the gap is smaller and allow transfer of vibrational energy to the hair during such coupling. The design of piezotransducers 36a or piezotubes 36 to achieve any or all of twisting, shearing, bending or length-wise compression or tension, whether cyclic or single-actuation, is widely known and each of these modes will excite and/or bend the teeth 35 differently.

The optional or alternate piezoelements 36a may be utilized to do one or more useful things to achieve the desired operation. Piezoelements 36a embedded in or on teeth 35 may be used to oscillate teeth to achieve one or both of gripping and energy transfer. For example, bending piezoelements 36a could cause gaps to controllably vary. Within the scope of the invention is the use of piezopolymers, even to form teeth 35 or backbone 34 directly. Also, bimorph bending transducers 36a, regardless of whether they are piezoceramic or piezopolymeric in nature, may be applied, such as to bend teeth 35 to actuate and clamp hairs. Making an entire structure such as 35/34, out of a piezopolymer has the advantage of reduced parts count. Appropriate driving electrodes would be provided as is widely known to the piezoelectric art. We also include in our inventive scope not just transduction piezomaterials such as piezoceramics and piezopolymers for motion generation or clamping but also ferroelectrics, electrets, relaxors, magnetostrictive transducers, electrostatic transducers, electromagnetic transducers, photoacoustic transducers, thermomechanical transducers (e.g., bimetals) and optoacoustic transduction means. As is known to the arts of transduction for generating motion or forces, such transduction means may be arranged as uniaxial, biaxial, rotary or bimorph designs for example. The simplest, which we depict herein, are simple bar-mode (lengthwise deformation) and torsional-mode (shear deformation) piezoceramics.

As an application example, for the apparatus of FIG. 4A we could have an ultrasonic comb 20e designed to invigorate hair-roots for the purpose of enhanced hair-health or hair-related scalp health. Along these lines, we could deliver vibrational energy into hairs 22 with a frequency of 10-100 KHz, for example. At such low frequencies, we can arrange for physical comb structures to macroscopically vibrate at one or more of their primary, harmonic or sub-harmonic frequencies. Note that the vibrating structures such as teeth 35 might be made of metal or some other high-elastic constant material, thereby promoting an even higher natural frequency and reduction of possibly undesired vibrational damping and resultant heating of the apparatus itself. We stress that such a comb could operate in a single-pulsed, few-pulse or continuous pulse mode, for example. By having piezoelements such as 36a dedicated to particular teeth 35 or to particular gaps, one may even vibrate teeth 35 or change gaps selectively and not in temporal unison. We include in the scope of the invention the sensing of one or more individual hairs, hair-motion and hair-gripping in our various inventive coupling means, perhaps with the same piezoelements 36a since they are already there. With such sensing, one could actuate a gripping action in accordance with a hair-presence or hair-size.

We stress that FIG. 4A (and the next FIG. 4B) are not drawn to scale just as for the previous Figures. Further, by “comb” 20e we do not necessarily imply that one would utilize this apparatus for all or for any normal everyday combing activity to neaten and style hair, although such a multipurpose comb is also within the scope of the invention. The “comb” 20e might just have a few short stiff teeth 35 and have a handle (not shown) such that it can grip a few chest-hairs at a time, for example. Also, we remind the reader that it may be highly beneficial to shave the treatment subject first and allow for some regrowth of stubble, and grip the stubble for the inventive treatment, thereby avoiding the rest of the hair shafts. We also note that by working with stubble, our vibrational or ultrasonic energy will mainly be able to travel only downwards. The cutting of hairs to a controlled (stubble-like) short length (as opposed to zero length) by any means is included in the scope of the invention, as it may be beneficial that the remaining hair shaft part has a length that has a desired acoustic or electrical resonance or anti-resonance. Typically, it will be beneficial to isolate the users hand-grip area from the vibrating teeth 35 and this can be done, for example, using the mentioned (not shown) handle. Note in FIG. 4A that only some of the teeth 35 are shown and others are indicated by phantom line 38a. In FIG. 4A, our transduction means is transducer 36 (and/or 36a) and our coupling means are the teeth 35 and their backbone 34 that connects them to the transducer 36. In the case of transducers 36a, they could function both as energy providers and coupling or gripping means. In any event, we will always have a source of energy and a means to couple it, sometimes those being the same entity.

The comb 20e might be battery powered or powered by an external power supply and connecting cord (not shown). An on/off button or activation trigger may be provided on the comb or separately (not shown). The user may employ an enhancement material, chemical or coating that one or more of a) improves hair-gripping for energy transfer, b) improves energy transfer once gripped, or c) improves energy transfer to a hair portion, particularly in cases wherein hard-gripping is not practiced and energy is delivered into or attenuated into a hair portion in a noncontact or flowable contact manner, or d) improves energy-conversion as by attenuation to heat, for example.

Numerous types of energy can be delivered into a hair portion without necessarily requiring a hard-contact or mechanical gripping-action. These types of energy include, but are not limited to, a) compressional or rarefactional acoustic-waves propagated through a flowable medium or liquid, b) RF energy delivered through a tolerable air-gap or controlled-attenuation medium, c) optical energy through a gap (or via physical contact), or d) microwave energy across a gap (or via physical contact). Recall that the piezoelement energy sources of FIG. 4A (and FIG. 4B) are but one of many possible energy sources to be used in the practice of the invention.

Another type of enhancement measure could be, for example, obtaining improved acoustic coupling using an ultrasonic coupling gel or oil, or obtaining improved RF coupling by applying an RF-lossy material to the hair-shaft, particularly near the scalp-line. Such enhancements could be surface-only or volumetric in nature. Optical coupling can certainly be enhanced by wetting hairs with a flowable liquid or gel with a controlled refractive index conducive to optical coupling.

Thus, one could cut hair shafts to a controlled short length, coat (or diffuse) the remaining stubs with an RF-lossy material, and apply RF whose attenuation is maximized in the stub coatings. The heat produced will propagate mainly down the hair-shaft and to the root. Energy leakage from the shaft will cause a lesser temperature rise due to the spatial heat-spreading with a dependence somewhere between 1/D² and 1/D³ with D being the lateral distance from the shaft as earlier mentioned.

An optical, RF or microwave applicator could have a shield which prevents the energy-type from going downwards into scalp tissue and cause it to mainly be laterally coupled into the hair stub, as shown by earlier FIG. 3A item 32b, if that is what is desired. In this manner, it is delivered via the wave guiding hair just to the hair or hair sub-scalp surface parts.

Moving now to FIG. 4B, we see a brush-like apparatus 20f having combing or brushing teeth 35a. A scalp 21 is depicted with a hair shaft or hair 22 which is wrapped into or intertwined with several of the comb teeth 35a helped by the action of the brush being moved (translated/rotated) in contact with hair 22. In this sectional brush-like apparatus 20f view of FIG. 4B, we are looking down the length of the brush cylindrical axis or the Y axis. Typically, teeth 35a would surround the brush diameter as depicted by phantom line, 38b. We note that the teeth 35a are of height H. Also note that the brush cylinder along the Y-axis is mainly comprised of two parts. The inner part is a piezotube piezotransducer 36b, again shown as a torqueing shear-type piezotube known to the art. The outer part(s) is a backbone shell 34a having teeth 35a protruding therefrom. It can be appreciated that this general arrangement is similar to that of FIG. 4A. Again, as for FIG. 4A, we show in FIG. 4B the teeth 35a vibrating with vibrational bending displacements indicated by lines 39. Again, the piezoelement or piezotube 36b, if pulsed or harmonically operated, is capable of causing the shown bimodal (back and forth) vibrations 39 of the protruding teeth.

Note that the hair 22 of FIG. 4B is depicted as being entrained in several teeth 35a. This can assure a good grip and a controlled stick-slip grip, if desired.

For both the embodiments of FIGS. 4A and 4B, one would beneficially mold the backbone (34 or 34a) and the mounted teeth (35 or 35a) as a single part, if possible. One might drive the transducer(s) 36b or 36a at or in one or more vibrational modes such that teeth 35 or 35a of different lengths or resonant frequencies are all excited, at least separately if not simultaneously.

We include in the scope of the invention the use of auxiliary means such as vacuum, tacky-hair or apparatus coatings, adhesives, capillary wetting or electrostatics to help grip, attract, sort or entrain hair-portions. Thus, it is not required that the treating-energy transduction or source-means provide the energy for such gripping or clamping, although it may. It is only required that sufficient gripping, clamping or contact or “non-contact” coupling of any type be provided to transport a treatment energy in a useful quantity. A coupling that comprises RF-coupling tolerant of a small air-gap is a good example of “non-contact” (contact not required) coupling that does not necessarily involve mechanical clamping or gripping that may preclude any relative motion. In the case of RF heating of a hair shaft, it may actually be beneficial that the RF coil portion does not tightly grip the hair, as that may act as a potentially undesirable heat-sink in some designs.

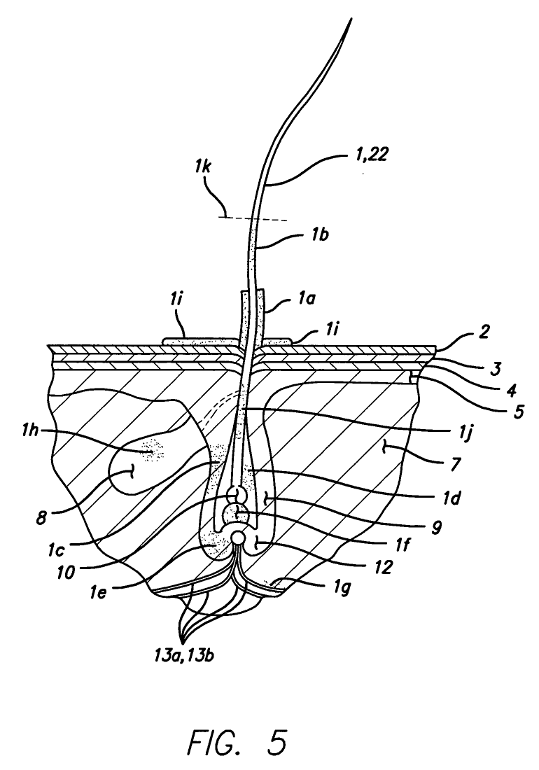

Moving now to FIG. 5, we see a sectional depiction of a hair much like that in FIG. 1 with the same hair-parts labeled. However, in FIG. 5, we have shown a number of enhancement coatings or diffusants that are placed on or in a hair-portion for the purpose of enhancing our treatment operation in some manner. As previously stated, such a coating, for example, may enhance ultrasonic, optical, RF or microwave energy conversion or attenuation to heat or may enhance the passage, conduction or wave guiding of the energy. It may also enhance an aspect of coupling or thermal sinking as for enhancing a gripping or clamping action, an acoustic water-like contacting, or a heat-conducting behavior. Such coupling may be contact-required or non-contact-sensitive. Specifically, in FIG. 5, we note the following depicted enhancer coatings, diffusants and alterations of a surface and bulk nature:
Item 1a is a hair-shaft coating near or at the tissue surface;
Item 1b is a hair-shaft diffusant shown on a hair-portion above the tissue;
Item 1c is a coating or diffusant in a mid-portion of the outer root sheath;
Item 1d is a coating or diffusant inside the outer root sheath;
Item 1e is a coating or diffusant in the generation zone;
Item 1f is a coating or diffusant beneath the keratization zone;
Item 1g is a coating or diffusant in or on supportive vasculature;
Item 1h is a coating or diffusant in or on a sebaceous gland portion;
Item 1i is a coating or diffusant in or on surface tissue close to the hair shaft; and
Item 1j is a coating or diffusant in or on a sub-dermal portion of the hair-shaft or inner sheath.

We stress that the enhancement material may be delivered in any fashion locally or systemically at any time before, during or after one or more treatments. If it were delivered after a single treatment, it would have a post-processing effect based on previously-provided energy. The enhancement material may also be or include a medicament or drug that relieves potential pain or which makes target portions more biologically or physically susceptible to or absorbing of the treatment or of one of its converted energies. Particularly attractive enhancement materials enhance the guiding or attenuation of a treatment energy such as an ultrasonic, acoustic, vibratory, optical, RF or microwave energy. Note that “coatings” may be deposited coatings or may be conversion-coatings wherein the hair itself (or other portion) is chemically or structurally altered to some depth, perhaps to full-depth (to the central core) in a bulk manner.

We note that item 1k in FIG. 5 is a potential cutting line for the hair shaft. The remaining portion below line 1k can be termed the stub. One may perform such trimming 1k and then apply an enhancer, or may alternately apply an enhancer and then trim. Trimming 1k is not required of the invention but in many embodiments utilizing close in (to tissue) coupling, it is preferred. Enhancement is also not required but will be beneficial in many cases. We note that our inventive apparatus may also provide this trimming function if that is attractive.

Included in the scope of the invention is any treatment-energy coupling to or gripping to of a cut end 1k of a remaining hair stub (coupled apparatus not shown). For example, one could deliver ultrasound or optical energy lengthwise into the cut end mainly as opposed to diametrically into the hair-shaft walls mainly. Thus, cutting of the hair 1 or 22 such that its cut end has a coupling-friendly shape or surface quality is within the scope of the invention. We explicitly note that if a hair shaft is first coated and then cut to a stub, then the cut end of the stub will have the hair-core exposed for very favorable optical coupling into the coated-hair end, for example.

It should be apparent now that the invention avoids prior art selectivity-tuning to avoid unwanted treatment of scalp portions not directly related to or supportive of targeted hairs. While our invention may utilize enhancement materials, they are not for the purpose of protecting inadvertently energy-exposed scalp and are therefore not providing a masking function. We do not blanket expose or expose such inter-hair scalp regions, thus, they do not need good selectivity or such labor-intensive and possibly toxically-harmful masking. This is fundamentally unlike the prior art.

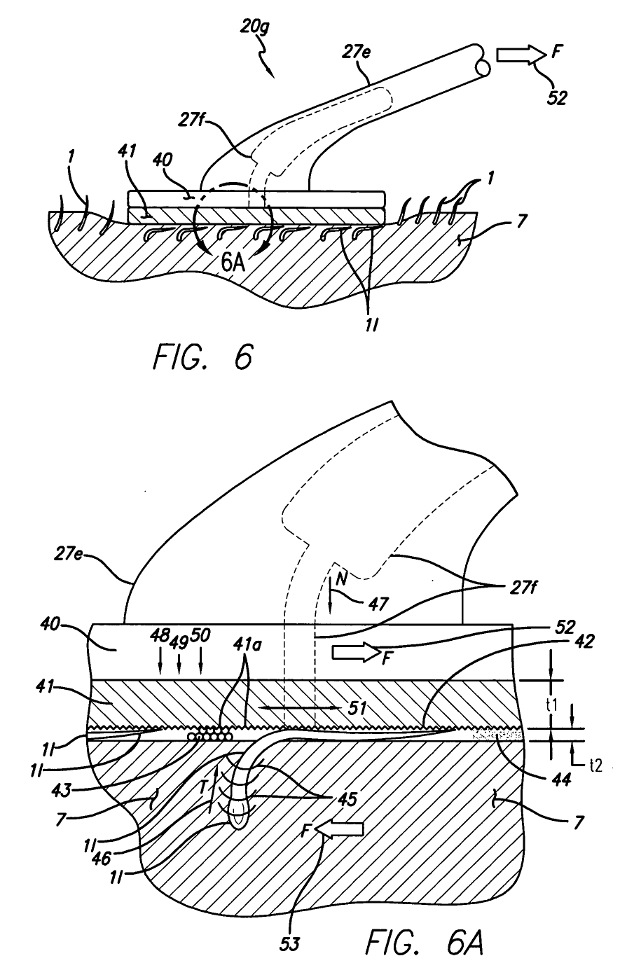

Finally, we refer the reader to FIG. 6. Therein is depicted a handheld version of an inventive apparatus 20g which is ultrasound/vibration powered and which is designed to kill or remove multiple hairs 1. In the top part of FIG. 6, we see the handheld apparatus 20g being dragged or pulled from left to right (from −X to +X direction) by a force F item 52 such as would be applied by the user's hand (hand not shown) on the handle 27e. Note that the apparatus 20g has the familiar handle 27e and has a tissue-contacting pad region comprised of a backer 40 and a shearing piezotransducer 41 (for example) mounted thereto. Also note that the handle and backer 27e and 40 have an internal lumen and reservoir 27f shown in phantom for one or more medicament, treatment, couplant or cooling agents or media to be dispensed into the tissue-contact region. Some hairs 1 which have been wiped or squeezed downwards by apparatus 20g are indicated as hairs 1l.

To better understand the operation of the apparatus 20g, we provide an enlarged view in FIG. 6A. In FIG. 6A we see the following. The shearing piezotransducer 41 has a thickness t1 across which shearing deformation takes place. A variable small gap 44 exists between the shearing transducer 41 and the skin tissue 7. A couple of hairs 1l are shown laid over and squeezed in the gap 44 along with surrounding oil or gel lubricant material which otherwise preferably substantially fills the gap 44. The transducer 41 shearing action causes the bottom surface of the transducer 41 to oscillate back and forth a small amount as arrows 51 indicate, generally along the ±X-axis in this example. The top of the transducer 41, as shown, is rigidly fastened to the handle 27e which also likely has higher inertia than the movable portion such that the hairs can be favorably driven. Note further that in FIG. 6A, the dragging force 52 is, at least intermittently, substantially counterbalanced by a reaction force 53 from the treatment subject. In FIG. 6A, the apparatus 20g is loaded against the tissue laterally with force F 52 but is not moving (translating) rightward at the depicted instant due to contact friction causing reaction force 53, which, as we will see, are at least in part due to bound hairs 1l. It should be apparent that at least transient gripping of the hairs is required in order to tension them, preferably while they are receiving treating energy that can be passed into and along the hairs and to the roots. Note that such at least transient tension can be applied with the hairs squeezed flat upon the scalp (shown) or by the hairs being lifted in tension from the scalp (not shown). In the latter case, more of the treating energy propagates along the hair shafts and into the hair substructures such as the roots and vasculature.

In the shown gapped approach, gap 44 is of typical average thickness t2, and is preferably filled or coated with a lubricant such as an oil or gel. The shearing transducer 41, on its bottom face has micro-roughened surface features 41a shown as tiny machined or patterned ridges or teeth 41a, for example. The idea here is that the teeth 41a grab the hard unpliable hairs 1l but do not effectively grab the tissue 7 because the hairs are hard whereas the tissue 7 easily deforms or is removed by the teeth. Thus, if one preloads the apparatus 20g rightwards (+X direction) with a force F 52/53, then the underlying hair 1l can be stretched into tension as depicted. It is preferably the stretched and harder hairs that mainly prevent further sliding rightwards and not the friction with the lubricated tissue. In this manner, some treating energy enters the hair shafts and propagates downward to the hair roots. Some treating energy is dissipated as slight warming in the gel and tissue between hairs.

Given that the apparatus 20g is at least momentarily statically hung-up from sliding due to the grabbing hairs/teeth interface, then any shearing vibration 51 applied to the tissue and hairs 7 and 1l will result in an oscillatory tensile force on the hairs superimposed on the static drag force F. This oscillatory tensile force is shown as T or item 46 and its tendency is to try and drag the hair root upwards in the positive Y direction. Assuming tension T is below the failure point of the root, then the oscillatory tension will be deposited as thermal energy and/or vibration stimulation in the root region. To be clear, indicated tensile force T 46 on hair 1l is typically due both to the static force F 52/53 as well as the superimposed oscillatory transducer 41 force, assuming static force F is still present during shearing vibration of transducer 41. We have shown ultrasonic waves 45 traveling down the hair shaft 11 as a result of the operation of the transducer 41. These may also travel upwards if the drag force is reversed slightly forcing taut hairs backwards into their follicles. In that case, one may even cause an alternatively useful compression of the hair (as opposed to tension).

It will now be apparent to the reader in FIG. 6 and FIG. 6A that the goal is to grasp the hairs 1l sufficiently to deposit vibratory or ultrasonic energy in the hairs while not doing unacceptable damage to intervening tissues. In fact, this is quite easy to do in a manner wherein the hairs are grabbed yet the intervening tissue receives or experiences what amounts to a-known beneficial microabrasion and slight warming at worst.

We have also shown in the FIG. 6A gap 44 the placement of particulate grit 43 in the gap, preferably entrained within the gap liquid or gel. Such abrasive grit may be used in addition to or instead of microteeth 41a. Many types of grit for abrasion are available, including carborundum, diamond, alumina, and other ceramic materials. It is beneficial in our inventive applications to utilize a sterile grit that is as hard or harder than the hairs being gripped such that the grasping grit does not mechanically fail. Typically, such grits used for microabrasion have been in the 25-100 micron range in particle mean-size. In our applications herein, one would preferably desire a hard rough grit particle or a hard angulated grit particle, either of which will bind against the hair and against the face of the transducer 41 but will not be able to bind the skin against moving. If both grit 43 and microteeth 41a are employed, then the grit 43 should be harder than the hairs but softer than the microteeth, such that the microteeth are not quickly eroded away and the grit lasts for at least one treatment, preferably being consumable.

Within the scope of the invention is the provision of grit and/or lubricant as a disposable material or in a sterile prepackaged container or applied film. Also within the scope of the invention is the provision of the grit and/or lubricant in the form of a sterile sheet of material, or infused in a sheet of material wherein the sheet serves as a matrix to hold the grit and/or lubricant. One might also choose to provide such a grit/lubricant or grit sheet in the form of a sheet that is adhesively attached to the transducer 41 face. Preferably, such a sheet avoids any cleanup and is a disposable co-product. The sheet may even be meltable or liquefying with use or with heat application. This can be achieved as by immersing the grit in a meltable wax such as a paraffin or in a thermoreversible gel.

We note in FIG. 6A the arrows 48, 49 and 50. These are intended to under-score the fact that the inventive apparatus may deliver other services, energies, electrical or magnetic fields, medicaments or therapeutic mediums to the tissue 7 and/or hairs 1l in addition to the depicted primary ultrasonic, vibratory or RF examples or the nondepicted optical and microwave primary treatment-energy examples. Such flows or fields may be oriented or directed downwards, upwards, laterally or in multiple directions relative to the gap or to the treatment sites. For example, conducted, radiated or convected heat flow downwards to the hair/scalp for the purpose of heating could be provided. Likewise, cooling by the apparatus could cause upward flow of heat from the hairs/scalp if beneficial. Electrical bias could also be provided as for example to drive ionic drug species into the tissue. Light-energy could be provided to photo-stimulate or activate hairs, tissues or associated photoactive medicaments, target tissues or hair-coatings. Light-energy could include infrared energy in order to warm the treatment site or enhance perfusive bloodflow, as is known to be possible. Within the scope of the invention is the simultaneous or sequential use of such “services” together with the ultrasonic, vibratory, optical, RF, microwave or electromagnetic primary-treatment energy and/or force F.

Note that lumen and reservoir 27f is also shown in phantom in FIG. 6A. This reservoir could be used to deliver a drug, a desensitizer, a beneficial enzyme, a lubricant and/or grit, a coolant, an electrical couplant, etc. We stress that by “lubricant” we simply mean something that preferably reduces or otherwise beneficially controls a friction parameter with the skin tissue or hairs. This “lubricant” could even be water, for example, which is not normally thought of as a lubricant. The apparatus 20g may be provided with an auxiliary or co-integrated means to sterilize water or other flowable agents such as an ultraviolet lamp chamber (not shown).

We also note in FIG. 6A that a “normal” downward force N item 47 is depicted. Those familiar with mechanics and friction know that one generally needs a downward force N in order to obtain friction forces in the gap 44 if sliding is otherwise possible. This force N may be set by any means including manually or automatically, by vacuum suction, or simply by employing dead-weight or manual force. Once the microteeth 41a or grit 43 are indented into or bound to the hairs 1l, it may be possible to reduce this normal force without losing the hair-dragging forces due to such indentations or binding. In the case of lifting hairs upwards off the scalp in tension, the normal force becomes a tensile force applied to tensioned hairs as opposed to a compressive force applied to scalp and hairs.

It should be apparent that if the apparatus is lightly laid upon or pressed upon the skin 7 and slid somewhat before being pressed downwards to provide hair-grabbing or binding, that one will cause any and all such flattened hairs 1l to be pulled taut and generally parallel (as shown) and be readied for deposition of the ultrasonic or vibratory energy. Included in the inventive scope is all manner of sliding including lateral and rotational.

We note that the oscillation 51 may have any desired displacement or motion waveform including bipolar or unipolar, pulsed or continuous-wave (CW). It is not required that the dragging force F be exactly parallel to the transducer 41 oscillations 51 so long as useful hair-grabbing or binding and oscillation is achieved for the sliding embodiment. Oscillation may also be circular or orbital in nature, for example, rather than the depicted unidirectional oscillation. We include in the scope of the invention the oscillations such as 51 being any size, but most preferably, they are between a micron or so up to a few hundred microns in amplitude. In some cases, particularly for low frequencies or single-pulses of vibration, amplitude could even be measured in millimeters or centimeters. It may be beneficial to treat the hair shafts to increase their grabbability, as by providing a roughening or tacky coating or even an adhesive to preferably at least temporarily affix them to the transducer 41. Such a hair coating may also cap the pointed tip of hairs so as to avoid driving the tips into the tissue surface 7. It should also be obvious that the apparatus could operate in more than one direction or in a rotational direction, preferably with the hairs tensioned before the ultrasound or vibrational energy is applied.

It may be possible to allow the force F to go to zero, or close to zero, once the hairs are pulled taut or relieved of slack (and not necessarily left in significant residual tension). It will be recognized that once taut (that is, all slack has been taken up and residual tension is or is not present), then vibration of transducer 41 will be able to deliver ultrasonic or vibratory waves into the hair in both directions, that is, downwards as shown by waves 45 and rightwards as well in the flattened hair on the surface. Both such vibrations will be communicated into the hair shaft and root. It should be apparent that once taut, that compressive downwards waves 45 can be applied. The waves will tend to follow the hair shafts downwards in our inventive wave-guiding action. Again we note that the inventive apparatus allows delivery of treatment energy to first hair portions, such as subsurface hair-root portions, while they are laid-upon the scalp or while they are pulled free and upwards of the scalp in tension. An advantage of the laid-upon scheme is that the apparatus can also deliver treatment to or temperature-control of the scalp portions since in that mode they contact the apparatus. Alternatively, also included in our scope is noncontact hair/scalp warming using infrared light, for example.

Using apparatus 20g, one may deposit energy into hair-parts for both hair enhancement or invigoration, preferably at low stimulating powers, as well as for hair-elimination or growth-slowing, preferably at higher ablative, necrosing or genetic alteration powers as previously discussed for other embodiments. Note that by stimulation above we mean any beneficial stimulation including that provided by modest noninjurious warming, or by the ultrasonic, optical, RF or microwave waves themselves.

We note that the taught method of FIGS. 6 and 6A may be somewhat modified and still work beneficially. Anticipated modifications, for example, would allow the hairs 1l to be selectively bonded to the transducer 41 face (not bonded to underlying tissue 7) such that a lifting of the apparatus 20g to enlarge the gap 44 places the bonded hairs 1l in tension but they are no longer laying flat (shown) but are pulled upwards tensioning the roots. In that case, any transducer 41 which can apply any vibration or ultrasonic excitation that travels down the hair shafts will serve our purpose. Obviously, if the hair is lifted generally upwards into tension, then a transducer 41 that vibrates along the ±Y axis (vertically) will pass oscillatory energy into the tensioned hairs. So the core of this embodiment is really the selective grabbing of hairs versus scalp tissue in a manner wherein minimal or no sliding along the hairs takes place during energy delivery such that the energy sinks into the hairs and thereby into the first tarot portions, whether they be above the scalp or below the scalp.

The acoustic, ultrasonic or vibratory scheme shown in FIGS. 6 and 6A is very simple in that individual hairs are never manipulated one-at-a-time; the deslacking process is self-regulating and self-limiting, as excessive pulling of any individual hair will allow slippage, particularly at less than full normal load N. Thus, the key is simply to assure that hairs do not slip (once deslacked) yet contacting tissue, if any, can slip and deform or even somewhat beneficially abrade if desired. We note that per the earlier embodiments, we are applying a treating energy to a second portion and that energy is, at least partly, propagated towards the first target portion, a hair root in many cases, in some beneficial energetic form such as ultrasonic, heat or cavitation energy. Also explicitly note that by choosing a good tissue lubricant, we can avoid any significant treatment of the surface tissue 7, but if desired we can co-deliver a beneficial abrasion or poration to the scalp tissue, a treatment that is a different treatment than the one the hair itself is getting. Since the treatments are different in nature there is no selectivity for a given treatment type as for prior art.

It will also now be apparent that a stick-slip phenomenon between the hairs and the transducer (or actuator) 41 face may be tolerable, as acoustic, ultrasonic or vibratory energy delivery to the hairs will still take place at least during periods of nonslip for the particular hair in question.

Vacuum suction or electrostatic attraction and clamping may be useful to provide hair-grabbing as-well or instead of the frictional grit or microteeth approach depicted. Another advantage of the apparatus of FIGS. 6 and 6A is that the gap inter-face may be curvilinear if not user-deformable. This can be quite beneficial when trying to couple to a hard yet-curved scalp while trying to simultaneously treat several hairs at once.

One may even forcibly extract hair from the scalp using the apparatus 20g, most beneficially after some energy has been delivered to the root structure to disrupt, ablate, numb or desensitize it. Such removal may be provided by increasing force F and/or by providing a single large unidirectional pulse to the transducer. We include in the scope of the invention the use of asymmetric waveforms 51, which result in a tendency of the apparatus 20g to translate across the tissue or hair surfaces or to extract the hairs from the scalp. Such migration may also provide constant deslacking of remaining bound hairs. Outright extraction using apparatus 20g may be done after or at a later time than a treatment, particularly after the root damage has fully evolved and/or any temporary irritation has passed. Note that any pain may favorably be masked by the vibrating and/or normally-loaded tissue/hairs.

It will also be apparent that apparatus 20g may be provided as a wearable patch (preferably less the handle 27e), particularly in the case wherein gravity or dead-weight provides the deslacking step. Such a patch may be disposable if not battery powered.

The apparatus 20g surface that actually abuts the gap 44 need not be formed by the transducer or actuator 41 itself. It should be obvious that a further layer (not shown) may provide the actual gap 44 contact. Such a layer or porous layer may also serve as an electrode, medicament reservoir, optical window, etc. Note that such a porous layer may also serve the microteeth or grit function, assuming the porous material is hard-enough to grip the hairs. Ideally, this layer is provided in the form of a disposable pad or tape.

Force F may also be provided as by an elastomeric member (not shown). For example, a treatment patch apparatus 20g (less handle) may be tensioned by an elastic adhesive-attached adjacent member or even by having an elastically deformable contact-surface that is an integral part of the apparatus 20g.

Apparatus 20g may be disposable or may have disposable or replaceable portions such as a disposable gap film that fills the gap and then is disposed of. The gap material may be complete in that it is placed or dispensed as-is with no further ingredients, or may be mixed or combined with other ingredients such as with water.

An attractive scheme is a disposable gap sheet (or roll) material that is a hydrogel which, when wet (may be prewetted), is a superb and sterile lubricant for the tissue. Such a film may also carry grit, microteeth-equivalent features such as made by micropatterning, for example, or a beneficial drug or cosmetic material.

Apparatus 20g, preferably less handle 27e, may also be provided as a wipe or sponge that is highly conformable. This could be achieved, for example, by either of a) having transducer or actuator 41 utilize flexible piezopolymeric material, or b) have the gap film be somewhat spongy or viscoelastic for slow deformations, yet not too attenuative and somewhat porous and gritty to grab the hairs. Note again that such a “wipe” may comprise a nondisposable transduction component and a disposable gel or pad wipe component.

The apparatus 20g may even be operated in a high power mode wherein hairs are intentionally “machined off” the tissue surface in a few pulse cycles or less. This would be like razor shaving but would offer the advantage that the large-area contact of the transducer 41 and its vibration and/or medicaments mask any pain associated with the process. Essentially, this amounts to abrasive shaving and such shaving is also included in the scope of the invention. Depending on the operating conditions, this approach may or may not either of damage, kill or even invigorate the hair root structures. As accompanied by infrared light irradiation, it also will enhance scalp perfusion.

We note that in some cases the “deslacking step” can be achieved simply by squeezing down the hairs 1l even if they are curved as laid-flat on the scalp. Once compressed flat, then any vibrational displacement of transducer 41 will be felt directly at each hair's entry point into the scalp as it is normally loaded at that entry point. Thus, what is necessary is to couple vibrational energy into the root without having most of that energy dissipated in slack or in hair-abutting tissue. The portion of the hair 1l exiting the scalp and turning sideways (assuming it is laid flat) will always absorb some vibratory energy, particularly if it itself is touching the juxtaposed transducer 41.

In the deslacked hairs case of FIG. 6A, we know the orientation of the hair and we know the orientation of the transducer displacement relative to the hair. Thus, energy is delivered along the length of the laying hair as well as into the portion that curves downward into the scalp tissue. Some of that energy injected into the laying hair-length will be dissipated into the adjacent scalp before it gets to the curved region going into the scalp. In the case wherein deslacking is avoided by simply pressing hairs down flat, even if they are curved when flat, we get a random set of hair orientations relative to the transducer displacement (assuming that displacement is unidirectional). If transducer 41 displacement were instead circular or orbital, then each laid-flat curved hair would get the same average energy exposure from all directions, particularly at the shaft scalp-entrance.

One could make a good argument for deslacking in a first direction (hairs straight) and then apply vibrational power perpendicular or orthogonal to that direction. The idea is that energy coupled into the laid-flat hair goes into rolling the hair rather than causing the hair to scrub the scalp under it. The energy applied at the shaft scalp-entry still provides the desired treatment, as at least that shaft portion acts as the inventive waveguide or preferred energy conduction path into the scalp.

Those familiar with scalp hairs, for example, know that hairs do not necessarily exit the scalp vertically but frequently have a preferred knap and an angled exit. Included in the inventive scope is the accounting for that knap in choosing any of the taught operating parameters. As an example, it would probably be beneficial, if deslacking is desired, to do so along a natural direction or hair growth or even perhaps 180 degrees to that nap direction to enhance the exit-curvature of the hairs coming out of the scalp.

As a terminology point, we define a hair sidewall to be the outer cylindrical surface of a hair shaft. Thus in FIG. 6A, it should be clear that by confining the hairs to gap 44, we are transferring energy due to vibrations 51 into, through or along the hair 1l sidewalls.

Squeezing the hairs 1l into a gap 44, with or without deslacking, will result in some useful energy transfer into the hair root, particularly for acoustic, ultrasonic or vibratory energy coupled into the laid flat hair near the scalp-entry points. By deslacking, in some cases, even more vibratory energy can be transferred into the hair root, since the scalp is stretchable and the hair is not as stretchable. Thus the hair-root feels some of the pulling of the laid-flat hair shaft laying on the stretching tissue foundation. So we emphasize that deslacking may be preferred in some embodiments but is not a requirement for all embodiments.

What is claimed is:

1. An ultrasonic or vibratory energy apparatus for at least one of ultrasonically, vibrationally, thermally or ablatively treating at least a first portion of at least one hair, hair-shaft, hair root-structure, hair root-region, hair-follicle, hair-related scalp tissue or hair-supporting vasculature comprising:
an ultrasonic or vibratory energy transduction-means or energy-source capable of producing or providing ultrasonic or vibratory excitation energy;
an ultrasonic or vibratory energy coupling-member or coupling-medium which, when energy-coupled to a second portion, is capable of passing ultrasonic or vibratory energy from the member or medium into, upon, through or along the second portion;
the coupling member or medium and the energy means or source being the same, shared, or separate cooperating components;
the first and second portions being different or the same portion and being portions of the same or different hairs, hair-shafts, hair root structures, hair root regions, hair-follicles, hair-related scalp tissues or hair-supporting vasculature;
ultrasonic or vibratory energy thereby being deliverable into, upon, through or along the second portion from or by at least one of the coupling member or means, the energy transduction means or source, or by the cooperation of both; and
at least some of the ultrasonic or vibratory energy delivered or coupled at the second portion at least one of: a) at least partly propagating, conducting or passing as ultrasonic or vibratory energy to or into the first portion, or b) being at least partly converted to heat in one or more portions and being at least partly thermally propagated to or into the first portion, or c) being converted, at least partly, to heat at or in the first portion, d) at least partly arriving at, or propagating to the first portion as both some ultrasonic or vibratory energy and as some heat or thermal-energy, e) at least partly being propagated or conducted through, along or into at least one other portion, or f) being coupled to and employed to treat the same portion.

2. The apparatus of claim 1 wherein said propagation, conduction or passing is at least one of (a) in an acoustic-wave guiding manner along or through a hair portion, (b) along a path having a thermal conductivity, (c) along a path which attenuates some or all of the passing energy to heat, (d) as any form of acoustic or thermal propagation, or (e) vibrational loading of a hair shaft or root-portion.

3. The apparatus of claim 1 wherein a first portion and a second portion are any of: (a) the same portion, (b) different portions, (c) portions spaced apart from each other, (d) portions situated along a common propagation or conduction path, (e) adjacent portions, or (f) a hair-portion and a hair-root or vasculature portion.

4. The apparatus of claim 1 wherein a treatment is intended to at least one of: a) promote hair or hair-part growth, b) remove hair, c) kill hair, d) reduce, slow or stop hair or hair-part growth, e) promote hair or hair-part health, f) promote hair-root or hair-vasculature health, g) promote scalp health, or h) provide a hair or scalp-related cosmetic treatment.

5. The apparatus of claim 1 wherein an ultrasonic or vibratory energy or energy component, as delivered to a second portion, has a frequency in the range of 10 Hertz to 100 MHz.

6. The apparatus of claim 5 wherein the frequency is in the range of 10 KHz to 10 MHz.

7. The apparatus of claim 6 wherein the frequency is in the range of 10 KHz to 2 MHz.

8. The apparatus of claim 1 wherein at least one of:
a) energy arriving at the first portion from the second portion arrives mostly as ultrasonic or vibratory energy;
b) energy arriving at the first portion from the second portion arrives mostly as heat or thermal energy;
c) at least some heat or thermal energy is generated at or in the first portion by arriving ultrasonic or vibratory energy coming from the second portion;
d) the first portion receives or experiences both arriving ultrasound or vibratory energy and arriving, conducted, or locally-generated heat or thermal energy;
e) the first and second portions are the same, abutted, energy-communicative, thermally-communicative or physically juxtaposed portions; or
f) the first and second portions are arranged such that energy in ultrasonic, vibratory or thermal form passes along or through an intervening, overlapping or common hair portion.

9. The apparatus of claim 1 wherein any of a delivered energy, heat or heating caused by a delivered energy, a medicament, couplant or a treatment supporting-agent utilized in association with or by the apparatus provides any of a) pain relief, b) pain-masking, c) irritation reduction, d) swelling reduction, e) beneficial temperature control, or f) a numbing or desensitization effect if that is thought beneficial.

10. The apparatus of claim 1 wherein the apparatus at least one of:
a) includes a hand tool, handle or handheld treatment applicator;
b) includes a connected or supportive console or control box;
c) includes a treatment applicator connected to a console or box by a cord, cable or utility umbilical;
d) includes or utilizes a disposable or consumed part, couplant, medium or medicament;
e) includes or utilizes a replaceable part; couplant, coupler, medium or medicament;
f) is capable of being used with the help of optics or imaging for purposes of imaging or visualization of a treatment region;
g) is capable of communicating over or using any one or more types of data port or data network including the internet, intranet and data-paths of the apparatus itself;
h) is capable of recording a parameter of a treatment algorithm, a delivered treatment or patient information; or
i) operates manually, automatically, or with the help of firmware or software.

11. The apparatus of claim 1 wherein a hair, hair-part, hair-shaft, hair-follicle, hair-root, hair-supportive vasculature or adjacent hair-related scalp tissue is held, at any time for at least a transient or temporary period, in at least one of a) tension, b) compression, c) torsion, d) shear, e) pressurized contact, f) thermal contact, g) by a suction means, h) in a bent or distorted condition, j) with some slack-during ultrasonic or vibratory energy delivery, j) by a gripping surface or grit, k) in acoustic-coupling contact, l) in sliding, dragging or frictional contact, or m) in a temperature controlled state.

12. The apparatus of claim 1 wherein a supportive drug, medicament or energy-propagation or coupling enhancement medium is utilized in any manner including in the form of a) a systemic, ingested or inhaled drug or medicament, b) a topical drug or medicament, c) an applied or infused drug or medicament, d) a hair coating, e) a scalp coating, f) a drug or medicament favorably delivered or activated utilizing treatment energy or any thermal energy, g) a drug, medicament or medium deliverable to the treatment subject by or under the control of the treatment apparatus or the user thereof, h) a drug or medicament which is a constituent of a couplant medium.

13. The apparatus of claim 1 wherein at least some delivered, coupled, propagated or arriving energy at any said portion or portions forms or causes at least one of: a) cavitation, b) warming or heating, c) necrosis, d) ablation or burning, e) a genetic alteration, f) enhanced delivery, diffusion or activation of a medicament or drug in a region including of one or more hair roots or hair follicles, g) enhanced blood perfusion in a root region, or h) a beneficial numbing or desensitization.

14. The apparatus of claim 1 wherein before, during, or after a treatment of at least one hair, hair-part or any other of said portions, at least one hair shaft is trimmed, cut or shaved, any remaining above-scalp untrimmed portion, if any, optionally being allowed to at least partially regrow before at least one treatment.

15. The apparatus of claim 1 wherein any component of the apparatus or any consumed medium, couplant, coolant or medicament used therewith is consumable, disposable, replaceable, nontoxic or is dispensed or flowed by the apparatus, user or treatment-subject.

16. The apparatus of claim 1 wherein at least one hair or hair-related root or vascular scalp portion is, at least for a transient period, clamped, squeezed, gripped, compressed, prevented from sliding, deslacked, tensioned, controllably oriented or combed in any pattern including that wherein hairs are generally parallel.

17. The apparatus of claim 1 wherein the transduction means, energy source, coupling means or coupling medium includes, comprises or utilizes at least one of the following transduction technologies, transduction materials or energy-guides: a) piezomaterials, b) piezoceramics, c) piezopolymers, d) electrostrictive materials, e) ferroelectric materials, f) magnetostrictive materials, g) electromagnetic actuation, h) pneumatic actuation, i) hydraulic actuation, j) electrostatic transducers, k) capacitive transducers, l) thermoacoustic transduction or transducers, m) optoacoustic or photoacoustic transduction or transducers, m) bimorph transducer actuation, n) bi-metallic or differential-expansion laminate actuation, o) relaxor materials, or p) acoustic waveguides or resonators.

18. The apparatus of claim 1 wherein the apparatus includes any of: a) a rigid or compliant pad component placed against the scalp, b) a rigid or compliant comb-like component placed in contact with at least one hair, c) a rigid or compliant slidable or rollable scalp or hair-contacting component, d) a grippable or manipulating handle, e) a reservoir or means to dispense a medium selected from the group consisting of an energy couplant, a thermal couplant or coolant, a drug or medicament, a grit or other friction-control media, or f) a means to tension one or more hairs in any manner including possibly tensioning away from the scalp surface.

19. The apparatus of claim 1 wherein the apparatus includes an ultrasonic or vibratory exciter which provides at least one of a compressional, tensional. shearing or torsional motion, whether that motion be pulsed, continuous, oscillatory, harmonic or have an irregular waveform.

20. The apparatus of claim 1 wherein a hair, hair-shaft, or any said hair, hair-root or hair-vasculature portion is pulled from, extracted from, lifted from, freed from or falls free of the scalp or from the apparatus during or after a treatment, in any manner, including wherein the apparatus retains said removed hair, hairs or portions at least temporarily.

21. The apparatus of claim 1 wherein: a) hair removal comprises or includes removal of any of a hair-shaft, hair-root, or hair-vasculature portion, b) hair removal comprises or includes removal of the hair shaft and kills or disables at least a hair root or hair vasculature portion, or c) treating energy is delivered to a subsurface scalp hair-root or hair-vasculature portion either through an above-surface hair portion or through an exposed scalp portion juxtaposed to the hair to be treated.

22. The apparatus of claim 1 wherein a drug, medicament, hair coating, acoustic or thermal couplant, coolant, heat-transfer medium or chemical is applied to, infused into, coated upon or arranged, delivered or administered to modify a hair, hair portion or any said portion in a surface or bulk manner to enhance at least one of: a) the coupling of treating energy, b) the attenuation or conversion of treating energy to heat or thermal energy, c) the propagation or wave-guiding of treating energy or resultant heat, or d) the gripping, clamping or manipulative frictional-control of hair portions.

23. The apparatus of claim 1 wherein the apparatus is at least one of: a) operated or operable while plugged into a power outlet, b) battery operated or operable, c) rechargeable, d) useable in a shower or tub safely, e) operated using a contained or mated power-source, power-pack or fuel-cell of any type, f) capable of doubling as a hair shaver or razor, g) useable with one hand, or h) useable with two hands, at least one hand helping to mate the apparatus with a targeted said portion, hair or hair-shaft.

24. The apparatus of claim 1 wherein the ultrasonic or vibratory energy is at least one of: a) continuous wave, b) pulsed continuous wave, c) pulsed, d) sinusoidal, e) harmonic in nature, f) settable in amplitude, g) has a controlled waveform or spectrum, h) is delivered with an accompanying audible signal, i) has an audible component, j) has a duty cycle, k) is delivered with the knowledge of a hair gripping or clamping state, l) is of sufficiently high frequency to cause some attenuation to heat or thermal energy, or m) is of sufficiently low frequency to assure that significant ultrasonic or vibratory energy itself performs some useful treatment.

25. The apparatus of claim 1 wherein the application is at least one of for: a) home-use, b) salon, cosmetician or dermatologist use, c) lab use, d) daily or other regular use, e) use by the treatment subject, or f) use with an associated drug or medicament whether prescribed or not.

26. The apparatus of claim 1 wherein a gripping medium or means selected from the group consisting of microteeth, grit, or a rough or porous surface allow for the substantial gripping of a hair portion yet also allows for tissue to one or more of move, flow around or be acceptably or beneficially abraded by said teeth or grit.

27. An optical, radio-frequency or microwave treatment energy-delivery apparatus for at least one of thermally, ablatively or photo-optically treating at least a first portion of at least one hair, hair-shaft, hair root-structure, hair root-region, hair-follicle, hair-related scalp tissue or hair-supporting vasculature comprising:
an optical, radio-frequency, microwave or electromagnetic energy-source capable of at-least delivering or providing optical, radio-frequency, microwave or electromagnetic energy;
a means to energy-couple said source-energy into, onto or along a second such portion;
the first and second portions being different or the same portion and being portions of the same or different hairs, hair-shafts, hair root structures, hair root regions, hair-follicles, hair-related scalp tissues or hair-supporting vasculature; and
at least some of the treating-energy delivered or coupled at the second portion at least one of: a) at least partly propagating, conducting or passing, in the form of the treating energy, to or into the first portion, b) being at least partly converted to heat by attenuation in one or more portions and thereby being at least partly thermally propagated to or into the first portion, c) being converted, at least partly, to heat at or in the first portion, d) at least partly arriving at, or propagating to the first portion as both some treating energy and as some heat or thermal-energy, e) at least partly being propagated or conducted through, along or into at least one other portion, or f) being coupled-to and employed to treat the same portion,
the first and second portions being different portions or the same portions.

28. The apparatus of claim 27 wherein any of optical, radio-frequency or microwave energy is wave-guided by a hair-shaft or any surface or subsurface portion thereof.

29. The apparatus of claim 28 wherein waveguided includes the treating waveforms of energy favorably propagating or passing in a direction beneficial for treatment of a first portion.

30. The apparatus of claim 27 wherein any hair, hair-root, hair-vasculature or scalp portion has its propagation or attenuation of the treating energy purposely enhanced by any artificial medicinal, chemical or physical means in support of a treatment.

31. The apparatus of claim 27 wherein the treatment is being applied in any of the following manners:
a) as a single treatment;
b) as a series of treatments;
c) as a way to remove hairs;
d) as a way to inhibit hair growth;
e) as a way to encourage hair growth;
f) as a way to improve scalp health; or
g) by hand by the treatment subject or by a second treating person.
